(19) United States
(12) Patent Application Publication
(10) Pub. No.: US 2025/0219688 A1
(43) Pub. Date: Jul. 3, 2025

(54) RECIPROCITY-AIDED ITERATIVE BEAMSPACE INTERFERENCE SUPPRESSION

(71) Applicant: Telefonaktiebolaget LM Ericsson (publ), Stockholm (SE)

(72) Inventors: Amr EL-KEYI, Kanata (CA); Chandra BONTU, Nepean (CA)

(21) Appl. No.: 18/879,361

(22) PCT Filed: Jun. 29, 2022
(86) PCT No.: PCT/IB2022/056078

§ 371 Date: Dec. 27, 2024

(51) Int. Cl. H04B 7/0456; H04B 7/0452

(52) U.S. Cl. CPC H04B 7/0465; H04B 7/0452

(57) ABSTRACT

According to some embodiments, a method performed by a network node for interference aware downlink transmission includes determining a reciprocity-aided interference aware transmission precoder based on a downlink wideband interference covariance matrix estimated from a plurality of received sounding reference signals and based on a matrix inversion associated with the downlink wideband interference covariance matrix. The matrix inversion is determined based on an iterative inverse covariance estimation. The method further includes transmitting a downlink signal using the reciprocity-aided interference aware transmission precoder.

### TECHNICAL FIELD

Embodiments of the present disclosure are directed to wireless communications and, more particularly, to reciprocity-aided iterative beamspace interference suppression.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Managing inter-cell interference can significantly increase the throughput of cellular systems especially in dense deployment scenarios. For multiple input multiple output (MIMO) systems, downlink inter-cell interference management can be accomplished by designing the downlink precoders such that the transmitted power is reduced in the spatial directions of the users in adjacent cells (see P. Cheng, M. Tao and W. Zhang, “A New SLNR-Based Linear Precoding for Downlink Multi-User Multi-Stream MIMO Systems,” IEEE Communications Letters, vol. 14, no. 11, pp. 1008-110 November 2010).

In massive MIMO systems, however, MIMO precoding significantly increases the complexity of wireless transceivers due to the high dimension of the spatial signal space (see F. Rusek, D. Persson, B. K. Lau, E. G. Larsson. T. L. Marzetta, O. Edfors and F. Tufvesson, “Scaling up MIMO: Opportunities and challenges with very large arrays,” IEEE Signal Processing Magazine, pp. 40-60, 2013). The computational complexity is further increased when interference-aware precoding is implemented due to the additional requirement of processing interference-related information. Fortunately, massive MIMO channels are expected to have low rank as communication occurs in a low-dimensional subspace of the high-dimensional spatial signal space (see A. M. Sayeed, “Deconstructing multiantenna fading channels,” IEEE Transactions on Signal Processing, vol. 50, no. 10, p. 2563-2579, 2002).

Beamspace transformation has been proposed to take advantage of the reduced rank of the signal subspace where a set of orthogonal beams are used to approximate the channel and reduce the complexity of subsequent signal processing operations for MIMO precoding (see A. Sayeed and J. Brady, “Beamspace MIMO for high-dimensional multiuser communication at millimeter-wave frequencies,” IEEE Global Communications Conference (GLOBECOM), 2013).

There currently exist certain challenges. For example, legacy implementation for interference-aware downlink precoder calculation requires inversion of the interference covariance matrix, whose dimension is equal to the number of antennas at the base station. For active antenna systems (AAS) with a large number of antennas, e.g., AIR 6488, the computational complexity of the matrix inversion may be too high for practical implementation.

### SUMMARY

Based on the description above, certain challenges currently exist with beamspace interference suppression. Certain aspects of the present disclosure and their embodiments may provide solutions to these or other challenges. For example, particular embodiments include an implementation of interference-aware downlink precoder calculation with reduced computational complexity compared to legacy solutions. Instead of explicitly estimating the interference covariance matrix and inverting the estimate to compute the precoder, particular embodiments iteratively estimate the inverse of the interference covariance matrix with reduced computational complexity.

Furthermore, in some embodiments the channel estimates and the inverse covariance matrix are transformed to beamspace and dimension reduction is applied based on the diagonal elements of the inverse interference covariance matrix as well as the power of the channel estimates. The precoder is then computed using the dimension-reduced channel estimates and/or the dimension reduced inverse interference covariance.

In general, particular embodiments include a reduced-complexity interference-aware downlink precoding algorithm that uses an iterative estimate of the inverse of the interference covariance matrix together with beamspace dimension reduction to reduce out-of-cell interference leakage to neighbor cells. Particular embodiments include a system and method for downlink interference-aware precoding that comprises the following steps.

Particular embodiments include estimation of out-of-cell interference residual vectors from sounding measurements that are used for iterative update of the inverse of the interference covariance matrix via a sequence of rank-1 updates. Some embodiments include beam reduction of the estimated inverse interference covariance matrix and/or the channel estimates of the target user. Some embodiments include calculation of the interference-aware downlink precoding matrix using the computed inverse interference covariance matrix and the channel estimates possibly after beam reduction.

Test results show that particular embodiments yield a performance substantially close to that of the full-dimension legacy implementation while significantly reducing the computational complexity of the precoder calculation.

According to some embodiments, a method performed by a network node for interference aware downlink transmission comprises determining a reciprocity-aided interference aware transmission precoder based on a downlink wideband interference covariance matrix estimated from a plurality of received sounding reference signals and based on a matrix inversion associated with the downlink wideband interference covariance matrix. The matrix inversion is determined based on an iterative inverse covariance estimation. The method further comprises transmitting a downlink signal using the reciprocity-aided interference aware transmission precoder.

In particular embodiments, the matrix inversion associated with the downlink wideband interference covariance matrix comprises a matrix inversion of a regularized version of the downlink wideband interference covariance matrix.

In particular embodiments, the iterative inverse covariance estimation comprises iteratively updating an inverse of the wideband interference covariance matrix from a plurality of channel estimation residual vectors using a sequence of rank one updates each corresponding to residual vector of the plurality of channel estimation residual vectors. The rank one updates may use the Woodbury matrix identity.

In particular embodiments, the iterative inverse covariance estimation comprises adding circular Gaussian noise vectors to each of the plurality of channel estimation residual vectors.

In particular embodiments, the iterative inverse covariance estimation comprises approximating instantaneous noise-dependent expressions by their expected values.

In particular embodiments, the determination of the reciprocity-aided interference aware transmission precoder is further based on beamspace dimension reduction. Beamspace dimension reduction may be applied on the downlink wideband inverse interference covariance matrix, on downlink channel estimates used for determining the reciprocity-aided interference aware transmission precoder, or both.

According to some embodiments method performed by a network node comprises determining a reciprocity-aided interference aware transmission precoder based on a downlink wideband interference covariance matrix estimated from a plurality of received sounding reference signals and based on a matrix inversion associated with the downlink wideband interference covariance matrix. The determination is based on beamspace dimension reduction. The method further comprises transmitting a downlink signal using the reciprocity-aided interference aware transmission precoder.

In particular embodiments, beamspace dimension reduction is applied on the downlink wideband inverse interference covariance matrix, on downlink channel estimates used for determining the reciprocity-aided interference aware transmission precoder, or both.

In particular embodiments, beamspace dimension reduction is based on a spatial discrete Fourier transform basis vector based on an antenna array configuration of the network node.

In particular embodiments, a set of active beams used for the beamspace dimension reduction is selected based on channel power and/or inverse interference covariance.

In particular embodiments, the set of active beams comprises a fixed number of beams. The set of active beams may comprise a minimum number of active beams with a total collected power greater than or equal to a predetermined value and/or a number of beams each with a power above a threshold value.

In particular embodiments, the matrix inversion is determined based on an iterative inverse covariance estimation.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments provide a low complexity implementation for downlink interference-aware precoding by avoiding the inversion of the full-dimension interference covariance matrix. In particular, particular embodiments iteratively estimate the inverse of the interference covariance matrix and applies beamspace reduction to construct a downlink precoder that can suppress downlink intercell interference.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating an example of reciprocity-aided interference-aware transmission (RAIT) precoder calculation;

FIG. 2 is a block diagram illustrating reduced beamspace precoder calculation for a user equipment (UE);

FIG. 3 is a graph illustrating average downlink cell throughput versus number of users;

FIG. 4 is a block diagram illustrating an example wireless network;

FIG. 5 illustrates an example user equipment, according to certain embodiments;

FIG. 6A is a flowchart illustrating an example method in a network node, according to certain embodiments;

FIG. 6B is another flowchart illustrating an example method in a network node, according to certain embodiments; and

FIG. 7 illustrates a schematic block diagram of a network node in a wireless network, according to certain embodiments.

### DETAILED DESCRIPTION

Based on the description above, certain challenges currently exist with beamspace interference suppression. Certain aspects of the present disclosure and their embodiments may provide solutions to these or other challenges. For example, particular embodiments include an implementation of interference-aware downlink precoder calculation with reduced computational complexity compared to legacy solutions. Instead of explicitly estimating the interference covariance matrix and inverting the estimate to compute the precoder, particular embodiments iteratively estimate the inverse of the interference covariance matrix with reduced computational complexity.

Furthermore, in some embodiments the channel estimates and the inverse covariance matrix are transformed to beamspace and dimension reduction is applied based on the diagonal elements of the inverse interference covariance matrix as well as the power of the channel estimates. The precoder is then computed using the dimension-reduced channel estimates and/or the dimension reduced inverse interference covariance.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Although particular problems and solutions may be described using new radio (NR) terminology, it should be understood that the same solutions apply to long term evolutions (LTE) and other wireless networks as well, where applicable.

Particular examples are described with respect to a base station employing an M-element antenna array communicating with a user equipment (UE) equipped with N receive antennas. Let the N×M matrix Hᵢ(f,t) denote the matrix containing the coefficients of the downlink channel from the base station to the i-th UE at frequency f and time instant t. In time-division duplex systems where channel reciprocity can be assumed, the channel estimates are available at the base station, e.g., from uplink channel sounding transmissions, and are used to compute the precoding coefficients to transmit downlink data. The channel estimates can also be obtained using quantized feedback from the UE to be used by the base station in downlink precoding, e.g., Type 1 and Type 2 codebook-based beamforming in new radio (NR).

The base station utilizes an M×L precoding matrix \tilde{W}ᵢ(f,t) to transmit L≤min{M,N} spatial layers (streams) to the i-th UE. The matrix \tilde{W}ᵢ(f,t) is normalized such that \tilde{w}i,l^{H}(f,t)\tilde{w}_{i,l}(f,t)=1/L for l=1, . . . , L where \tilde{w}_{i,l}(f,t) denotes the l-th column of the matrix \tilde{W}ᵢ(f,t) and ( )^{H} denotes the Hermitian transpose of a matrix.

Some examples include reciprocity-aided transmission. Given the downlink channel estimates for the i-th UE, Hᵢ(f,t), the precoding matrix \tilde{W}_{i,RAT}(f,t) for the i-th UE can be computed based on a minimum mean square error (MMSE) design criterion. The reciprocity-aided transmission (RAT) precoder is computed by calculating the unnormalized precoder W_{i,RAT}(f,t) as

$${W}_{i , RAT} ( f , t ) = {\tilde{H}}_{i}^{H} ( f , t ) {( {\tilde{H}}_{i} ( f , t ) {\tilde{H}}_{i}^{H} ( f , t ) + {δ}^{2} {I}_{L} )}^{- 1}$$

where δ² is the MMSE regularization factor, I_{L} is the L×L identity matrix, and \tilde{H}ᵢ(f,t) the L×M matrix corresponding to the downlink channel of the i-th UE after port mixing/selection.

The matrix \tilde{H}ᵢ(f,t) can be constructed by selecting some rows of the full dimension downlink channel \tilde{H}ᵢ(f,t) based on some selection criterion, e.g., by selecting the rows with the highest norm. Alternatively, the selected channel matrix \tilde{H}ᵢ(f,t) can be constructed by mixing the rows of the full dimension channel Hᵢ(f,t), i.e., \tilde{H}ᵢ(f,t)=Uᵢ(f,t)Hᵢ(f,t) where Uᵢ(f,t) is the L×N port mixing matrix for the i-th UE. The rank-L MMSE precoder for each subband is given by \tilde{W}_{i,RAT}(f,t) and obtained from the matrix

$$\frac{1}{\sqrt{L}} .$$

Some examples include wideband reciprocity-aided interference-aware transmission. In dense deployment scenarios, where the base stations are closely located, the UE might receive interference from downlink transmissions of neighbor base stations that cause significant reduction in downlink throughput especially for UEs that are located on the cell edge. Interference-aware downlink transmission schemes design the precoding matrix such that the received signal power at the target UE is sufficiently high while limiting the interference caused at the UEs in the neighbor cells.

Let the M×M matrix Λ(t) denote the downlink wideband interference covariance matrix, i.e., the covariance matrix of the downlink channel vectors to out-of-cell users. In time-division duplex systems, the matrix Λ(t) can be estimated from the received uplink signal by the base station at sounding transmission instants. Let x_{RS,i,j}(f,t_{RS}) denote the uplink transmitted reference symbol from UE i from sounding reference signal (SRS) port j on subcarrier frequency f and time instant t_{RS} and let y_{RS}(f,t_{RS}) denote the corresponding M×1 received signal vector by the base station. Subtracting the expected received signal vector of sounding sequences transmitted by cell-attached UEs from the received uplink signal vector can generate a sample of the out-of-cell interference vector due to transmissions of out-of-cell users, i.e.,

$$r ( f , {t}_{R S} ) = {y}_{R S} ( f , {t}_{R S} ) - {\sum }_{i} {h}_{i j} ( f , {t}_{R S} ) {x}_{RS , i , j} ( f , {t}_{R S} )$$

where h_{i,j}(f,t_{RS}) is the estimated uplink channel vector of UE i transmitting from port j to the base station and the summation in the above equation is over the cell attached UEs that have scheduled uplink SRS transmission at frequency f and time instant t_{RS}.

The instantaneous wideband interference covariance matrix \hat{Λ}(t_{RS}) is then obtained by calculating the second-order statistics of the out-of-cell interference vector samples via averaging over different frequencies i.e.,

$$\hat{Λ} ( {t}_{RS} ) = \frac{1}{{N}_{f}} {\sum }_{f = 0}^{{N}_{f} - 1} r ( f , {t}_{R S} ) {r}^{H} ( f , {t}_{R S} )$$

where N_{f} is the number of frequency carriers used for uplink SRS transmission. The estimated uplink interference covariance matrix, Λ(t_{RS}), is obtained by temporal filtering of the instantaneous covariance matrix at each SRS transmission instant, i.e.,

$$Λ ( {t}_{R S} ) = ( 1 - β ) Λ ( {t}_{R S} - 1 ) + β \hat{Λ} ( {t}_{R S} )$$

where 0<β≤1 is the forgetting factor, i.e., β=1 corresponds to no temporal filtering. The filtered wideband interference covariance matrix at the latest sounding time instant, Λ(t_{RS}), is used as an estimate for Λ(t) until the filtered estimate from the next sounding transmission time slot is available.

The reciprocity-aided interference-aware transmission (RAIT) precoder is computed by calculating the unnormalized precoder W_{i,RAIT}(f,t) for the i-th UE as

$${W}_{i , RAIT} ( f , t ) = {( Λ ( t ) + {δ}^{2} {I}_{M} )}^{− 1} {\tilde{H}}_{i}^{H} ( f , t ) {( {\tilde{H}}_{i} ( f , t ) {( Λ ( t ) + {δ}^{2} {I}_{M} )}^{− 1} {\tilde{H}}_{i}^{H} ( f , t ) + {I}_{L} )}^{− 1}$$

and the normalized RAIT precoder \tilde{W}_{i,RAIT}(f,t) is obtained from W_{i,RAIT}(f,t) by scaling each of its columns such that its norm is equal to

$$\frac{1}{\sqrt{L}} .$$

Direct implementation of the RAIT beamformer requires estimation of the M×M matrix Λ(t) and inversion of Λ(t)+δ₂I_{M}. The computational complexity of these operations may be too high for practical implementation for massive MIMO base stations due to the inversion of the regularized interference covariance matrix, i.e., (Λ(t)+δ²I_{M})⁻¹, as well as the matrix multiplication (Λ(t)+δ²I_{M})⁻¹\tilde{H}ᵢ^{H}(f,t).

Particular embodiments described herein reduce the complexity of RAIT calculation by reducing the complexity of the matrix inversion via iterative inverse covariance estimation and/or reducing the complexity of the inverse covariance and channel multiplication via beam reduction.

Particular embodiments include iterative inverse interference covariance estimation. Let {r(f,t_{RS})}_{f=0}^{N}^{_{f}}⁻¹ denote the set containing the M×1 SRS channel estimation residual vectors from different subcarriers at time t_{RS}. Particular embodiments iteratively update the inverse of the covariance matrix directly from the residual vectors using a sequence of rank 1 updates each corresponding to one residual vector. Some embodiments use the Woodbury matrix identity

$${( A + c b {b}^{H} )}^{- 1} = {A}^{- 1} - \frac{{A}^{- 1} b {b}^{H} {A}^{- 1}}{c + {b}^{H} {A}^{- 1} b}$$

where A is an M×M complex matrix, b is an M×1 complex vector and c is a scalar. Some embodiments repeatedly apply the matrix identity on the inverse of the filtered covariance matrix, i.e.,

$${Λ}^{− 1} ( {t}_{R S} ) = {( ( 1 − β ) Λ ( {t}_{R S} − 1 ) + {\sum }_{f = 0}^{{N}_{f} − 1} \frac{β}{{N}_{f}} r ( f , {t}_{R S} ) {r}^{H} ( f , {t}_{R S} ) )}^{− 1}$$

where the initial value of Λ⁻¹(−1) is selected as

$${Λ}^{- 1} ( - 1 ) = \frac{1}{ε} {I}_{M}$$

and ϵ<<1 is a scalar. The iterative algorithm for updating Λ⁻¹(t_{RS}) is given by:

Given the previous estimate Λ⁻¹(t_{RS}−1). At time t_{RS}, when {r(f,t_{RS})}_{f=0}^{N}^{_{f}}⁻¹ are available do:

$$Compute {S}_{0} ( {t}_{R S} ) = \frac{1}{1 - β} {Λ}^{- 1} ( {t}_{R S} - 1 ) - \frac{{Λ}^{- 1} ( {t}_{R S} - 1 ) r ( 0 , {t}_{R S} ) {r}^{H} ( 0 , {t}_{R S} ) {Λ}^{- 1} ( {t}_{R S} - 1 )}{{( 1 - β )}^{2} ( \frac{{N}_{r}}{β} + \frac{1}{1 - β} ( {r}^{H} ( 0 , {t}_{R S} ) {Λ}^{- 1} ( {t}_{R S} - 1 ) r ( 0 , {t}_{R S} ) ) )}$$

For f=1: N_{f}−1 do:

$$Compute {S}_{k} ( {t}_{R S} ) = {S}_{k - 1} ( {t}_{R S} ) - \frac{{S}_{k - 1} ( {t}_{R S} ) r ( f , {t}_{R S} ) {r}^{H} ( f , {t}_{R S} ) {S}_{k - 1} ( {t}_{R S} )}{\frac{{N}_{r}}{β} + {r}^{H} ( f , {t}_{R S} ) {S}_{k - 1} ( {t}_{R S} ) r ( f , {t}_{R S} )}$$

End for
Set Λ⁻¹(t_{RS})=S_{N}_{_{f}}⁻¹(t_{RS})

Because the RAIT precoder requires inversion of a regularized version of the wideband interference covariance matrix, i.e., (Λ(t)+δ²I_{M})⁻¹, particular embodiments modify the above iterative algorithm to compensate for the diagonal loading factor. In some embodiments, this is done by adding circular Gaussian noise vectors with covariance δ²I to the sounding residuals, i.e.,

$$\tilde{r} ( f , {t}_{R S} ) = r ( f , {t}_{R S} ) + n ( f , {t}_{R S} )$$

where n(f,t_{RS}) are independent identically distributed M×1 random circular Gaussian vectors with covariance δ²I_{M}. The samples {\tilde{r}(f,t_{RS})}_{f=0}^{N}^{_{f}}⁻¹ are used to update the inverse covariance as explained earlier.

Some embodiments iteratively update (Λ(t)+δ²I)⁻¹ directly without generating noise samples by approximating the instantaneous noise-dependent expressions by their expected values, i.e.,

$$\begin{matrix}( {r}^{H} ( f , {t}_{RS} ) + & {n}^{H} ( f , {t}_{RS} ) ) {S}_{k − 1} ( {t}_{RS} ) ( r ( f , {t}_{RS} ) + n ( f , {t}_{RS} ) ) \approx \\ & {r}^{H} ( f , {t}_{RS} ) {S}_{k − 1} ( {t}_{RS} ) r ( f , {t}_{RS} ) + {δ}^{2} tr \{ {S}_{k − 1} ( {t}_{RS} ) \}\end{matrix}$$

$${S}_{k - 1} ( {t}_{R S} ) ( r ( f , {t}_{R S} ) + n ( f , {t}_{R S} ) ) ( {r}^{H} ( f , {t}_{R S} ) + {n}^{H} ( f , {t}_{R S} ) ) {S}_{k - 1} ( {t}_{R S} ) \approx {S}_{k - 1} ( {t}_{R S} ) ( r ( f , {t}_{R S} ) {r}^{H} ( f , {t}_{R S} ) + {δ}^{2} I ) {S}_{k - 1} ( {t}_{R S} )$$

Using the above approximations, in particular embodiments the iterative algorithm for the regularized inverse covariance matrix Γ⁻¹(t)=(Λ(t)+δ²I)⁻¹ is represented as
Given the previous estimate Γ⁻¹(t_{RS}−1). At time t_{RS}, when {r(f,t_{RS})}_{f=0}^{N}^{_{f}}⁻¹ are available do:

$$Compute {S}_{0} ( {t}_{R S} ) = \frac{1}{1 - β} {Γ}^{- 1} ( {t}_{R S} - 1 ) - \frac{{Γ}^{- 1} ( {t}_{R S} - 1 ) ( r ( 0 , {t}_{R S} ) {r}^{H} ( 0 , {t}_{R S} ) + {δ}^{2} I ) {Γ}^{- 1} ( {t}_{R S} - 1 )}{{( 1 - β )}^{2} ( \frac{{N}_{r}}{β} + \frac{1}{1 - β} ( {r}^{H} ( 0 , {t}_{R S} ) {Γ}^{- 1} ( {t}_{R S} - 1 ) r ( 0 , {t}_{R S} ) + {δ}^{2} tr \{ {Γ}^{- 1} ( {t}_{R S} - 1 ) \} ) )}$$

For f=1: N_{f}−1 do:

$$Compute {S}_{k} ( {t}_{RS} ) = {S}_{k - 1} ( {t}_{RS} ) - \frac{{S}_{k - 1} ( {t}_{RS} ) ( r ( f , {t}_{RS} ) {r}^{H} ( f , {t}_{RS} ) + {δ}^{2} I ) {S}_{k - 1} ( {t}_{RS} )}{\frac{{N}_{T}}{β} + {r}^{H} ( f , {t}_{RS} ) {S}_{k - 1} ( {t}_{RS} ) r ( f , {t}_{RS} ) + {δ}^{2} tr \{ {S}_{k - 1} ( {t}_{RS} ) \}}$$

End for
Set Γ⁻¹(t_{RS})=S_{N}_{_{f}}₋₁(t_{RS})

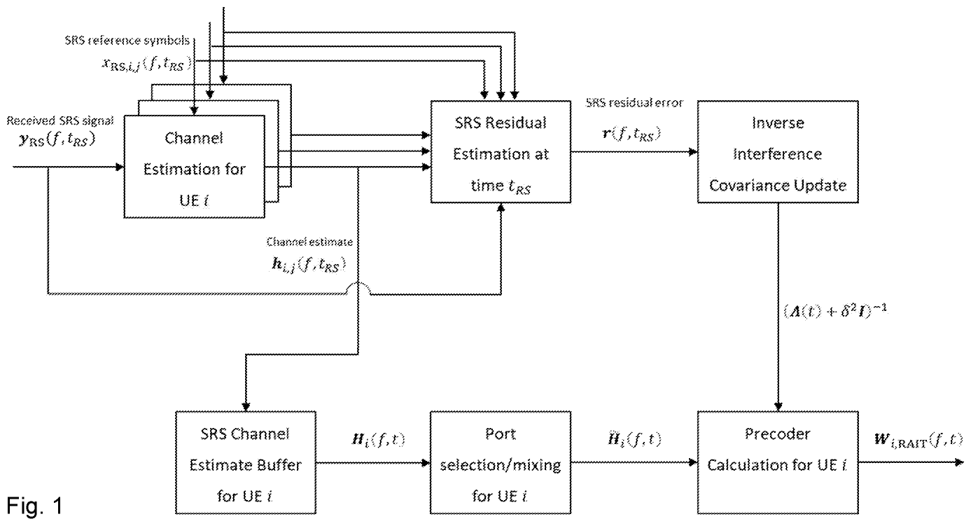

FIG. 1 illustrates a block diagram of the iterative RAIT precoder calculation method where the inverse covariance matrix is updated iteratively based on the above procedure from the sounding residuals and used to calculate the precoding matrix \tilde{W}_{i,RAIT}(f,t).

Some embodiments beamspace dimension reduction. Beamspace transformation has been previously used to take advantage of the low rank of the signal subspace where a set of orthogonal basis beams are used to approximate the downlink channel as a linear combination of a reduced-size subset of the orthogonal basis beams and the reduced beamspace basis subset is selected to provide the best approximation of the channel.

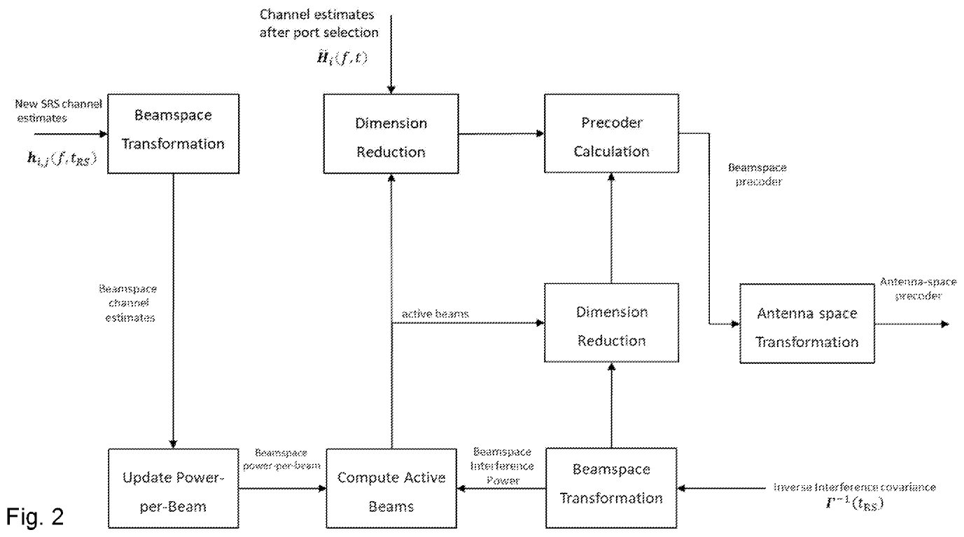

Particular embodiments described herein use beamspace dimension reduction on the downlink channel estimate and/or on the inverse of the interference covariance matrix to reduce the computational complexity of computing the RAIT precoder. In this case, the precoder calculation for UE i block in FIG. 1 is replaced by the reduced beamspace precoder calculation shown in FIG. 2 where the downlink channel and inverse interference covariance matrix estimates are transformed to beamspace and dimension reduction is applied on the inverse interference covariance matrix and/or on the beamspace channel estimates. The same set of active beams is used for dimension reduction of the channel and inverse covariance matrix where the criteria for selecting the active beams are based on the channel power and/or the power in the inverse interference covariance. The following algorithms may be used with respect to FIG. 2.

Some embodiments include beamspace transformation. Let the M×M matrix B denote the beamspace basis matrix. The columns of the matrix B can be composed of spatial discrete Fourier transform (SDFT) basis vectors based on the base station antenna array configuration. For example, consider a polarized two-dimensional antenna array at the base station where M_{V} and M_{H} denote the number of rows and columns of the two-dimensional antenna array at the base station, respectively, i.e., the total number of antenna elements is given by M=2M_{V}M_{H}. The M×M matrix containing the basis of the SDFT beamspace basis matrix is given by

$$B = {I}_{2} ⊗ {D}_{H} ⊗ {D}_{V}$$

where I₂ is the 2×2 identity matrix, and the two matrices D_{H} and D_{V} are M_{H}×M_{H} and M_{V}×M_{V} DFT matrices, i.e., the (m, k) element of D_{X} is given by

$$\frac{1}{\sqrt{{M}_{X}}} {e}^{j \frac{2 π mk}{{M}_{X}}}$$

where m, k=0, . . . , M_{X}−1.

The L×M antenna-space channel of the i-th UE, \tilde{H}ᵢ(f,t), and M×M inverse of the wideband regularized interference covariance Γ⁻¹(t)=(Λ(t)+δ²I)⁻¹ are transformed to beamspace

$${\tilde{H}}_{i , Beam} ( f , t ) = {\tilde{H}}_{i} ( f , t ) {B}^{H}$$

$${Γ}_{Beam}^{- 1} ( t ) = B {Γ}^{- 1} ( t ) {B}^{H}$$

Dimension reduction may be applied on the beamspace channel estimates as follows

$${\tilde{H}}_{i , BeamRed} ( f , t ) = {\tilde{H}}_{i , Beam} ( f , t ) {D}_{i} ( r )$$

where Dᵢ(t) is a diagonal M×M containing ones at the locations of the active beams and zeros elsewhere.

Dimension reduction may also be applied on the off-diagonal elements of the beamspace inverse covariance matrix

$${Γ}_{BeamRed}^{- 1} ( t ) = {D}_{i} ( t ) {Γ}_{Beam}^{- 1} ( t ) {D}_{i} ( t ) + diagMtx \{ {\overline{D}}_{i} ( t ) {Γ}_{Beam}^{- 1} ( t ) {\overline{D}}_{i} ( t ) \}$$

where D̅ᵢ(t)+Dᵢ(t)=I and the operator diagMtx{X} constructs a diagonal matrix from the diagonal elements of the matrix X.

Several options may be selected for beamspace dimension reduction. For example, dimension reduction may be applied only on the channel estimates and the beamspace reduced precoder is calculated as

$${W}_{i , Beam , Chan} ( f , t ) = {Γ}_{Beam}^{- 1} ( t ) {\tilde{H}}_{i , BeamRed}^{H} ( f , t ) {( {\tilde{H}}_{i , BeamRed} ( f , t ) {Γ}_{Beam}^{- 1} ( t ) {\tilde{H}}_{i , BeamRed}^{H} ( f , t ) + I )}^{- 1}$$

Alternatively beam reduction may be applied only on the beamspace inverse covariance matrix, i.e.,

$${W}_{i , Beam , Cov} ( f , t ) = {Γ}_{BeamRed}^{- 1} ( t ) {\tilde{H}}_{i , Beam}^{H} ( f , t ) {( {\tilde{H}}_{i , Beam} ( f , t ) {Γ}_{BeamRed}^{- 1} ( t ) {\tilde{H}}_{i , Beam}^{H} ( f , t ) + I )}^{- 1}$$

Finally, beam reduction may be applied on both the channel estimates and the inverse covariance matrix where the precoder is given by

$${W}_{i , Beam , Chan \& Cov} ( f , t ) = {Γ}_{BeamRed}^{- 1} ( t ) {\tilde{H}}_{i , BeamRed}^{H} ( f , t ) {( {\tilde{H}}_{i , BeamRed} ( f , t ) {Γ}_{BeamRed}^{- 1} ( t ) {\tilde{H}}_{i , BeamRed}^{H} ( f , t ) + I )}^{- 1}$$

The beamspace precoder is converted back to antenna space W_{i,RAIT}(f,t)=B\tilde{W}_{i,Beam,X}(f,t)

Some embodiments include a beam selection metric computation. Several criteria may be used for selection of active beams used in dimension reduction of the UE channel and/or inverse covariance matrix. The selection criteria may be based on the channel power of the UE and/or the power of the inverse interference covariance as follows.

In some embodiments, the selection criteria is based on filtered channel power. In this case, first the wideband instantaneous power per beam for the i-th UE is computed from the channel estimates obtained from the sounding reception, i.e.,

$${p}_{H , i} ( b , {t}_{RS} ) = \frac{1}{{N}_{f}} {\sum }_{f} {\vert {[ {B}^{H} {h}_{i , j} ( f , {t}_{RS} ) ]}_{b} \vert}^{2}$$

where h_{i,j}(f,t_{RS}) is the M×1 uplink channel vector obtained from the SRS reception at time t_{RS} that was transmitted on SRS sounding port j and [x]_{b} denotes the bth component of the vector x. Next, the filtered power per beam, p̅_{H,i}(b,t_{RS}), is calculated as

$${\overline{p}}_{H , i} ( b , {t}_{RS} ) = γ {\overline{p}}_{H , i} ( b , {t}_{RS} - 1 ) + ( 1 - γ ) {p}_{H , i} ( b , {t}_{RS} )$$

where 0<Γ<1 is the temporal filtering memory parameter for the power-per-beam calculation. The filtered channel power at the latest sounding time instant, p̅_{H,i}(b,t_{RS}), is used as an estimate for p̅_{H,i}(b,t) until the estimate from the next sounding transmission time slot is available.

In some embodiments, the selection criteria is based on inverse covariance power. In this case, the filtered inverse interference power is obtained directly from the diagonal elements of the filtered wideband beamspace inverse covariance matrix as

$${p}_{{Γ}^{- 1}} ( b , t ) = {[ diag \{ {Γ}_{Beam}^{- 1} ( t ) \} ]}_{b}$$

where diag{X} denotes the M×1 vector obtained from stacking the diagonal elements of the M×M matrix X. The filtered interference power, p_{γ}_{^{−1}}(b,t), is used for all the UEs.

In some embodiments, the selection criteria is based on channel times inverse covariance power. The filtered power per beam, P_{H,i}(b,t), and the wideband inverse interference covariance power-per-beam p_{Γ}_{^{−1}}(b,t) are used to calculate the channel times inverse covariance power for the i-th UE as

$${p}_{H X {Γ}^{- 1} , i} ( b , t ) = {\overline{p}}_{H , i} ( b , t ) ( {p}_{{Γ}^{- 1}} ( b , t ) + a {\sum }_{b} {p}_{{Γ}^{- 1}} ( b , t ) )$$

where α<<1 is a regularization factor.

Some embodiments include active beam selection. Several methods are proposed for active beam selection using any of the above metrics. The active beam selection may be different for different UEs based on the selected metric. For example, using the filtered channel power or the channel times inverse covariance power might yield different active beams for different UEs. In contrast, using the inverse covariance power metric, the selected beams are the same for all UEs.

Let Aᵢ(t) denote the set containing the active beams for the i-th UE and let pᵢ(b,t) denote the metric used for beam selection for the i-th UE. The active beams can be selected using any of the following methods.

Some embodiments select the active beams using a fixed number of active beams method. These embodiments select a fixed number of beams that yield the maximum metric sum Σ_{b∈A}_{ᵢ}(t)pᵢ(b,t).

Some embodiments select the active beams using a collected power in active beams method. These embodiments select the minimum number of beams that have a total metric greater than a fraction κ of the total metric in all beams, i.e., the set of active beams is the solution to the following optimization problem

$$min \vert {A}_{i} ( t ) \vert subject to {\sum }_{b ∈ {A}_{i} ( t )} {p}_{i} ( b , j ) > κ {\sum }_{b} {p}_{i} ( b , t ) .$$

where |Aᵢ(t)| denotes the cardinality of the set Aᵢ(t).

Some embodiments select the active beams using a threshold based beam activation method. These embodiments select the beams that have a metric value greater than a threshold τ of the total metric, i.e., the set of selected active beams is given by

$${A}_{i} ( t ) = \{ b \vert {p}_{i} ( b , t ) > τ {\sum }_{b} {p}_{i} ( b , t ) \}$$

The performance of particular embodiments may be illustrated using numerical simulations. Particular examples simulate a time division duplex (TDD) system with bandwidth 36 MHz, subcarrier spacing 30 KHz, and carrier frequency 3.5 GHz. The example uses a multicell deployment scenario with 3 sites and 3 cells/site where the inter-site distance is 200m. The UEs are equipped with 4 antennas each and are dropped randomly in the simulation area. The 5G spatially correlated model Urban Macro channel model is used in this simulation. The antenna configuration at the base station is the active antenna system (AAS) 4×8×2 configuration. The traffic model for the downlink is selected as full buffer. The channel estimates are obtained using a full band sounding reference symbol which is transmitted by each UE every 6 msec from one antenna port and antenna port switching is enabled, i.e., complete channel information is obtained from all ports every 24 msec.

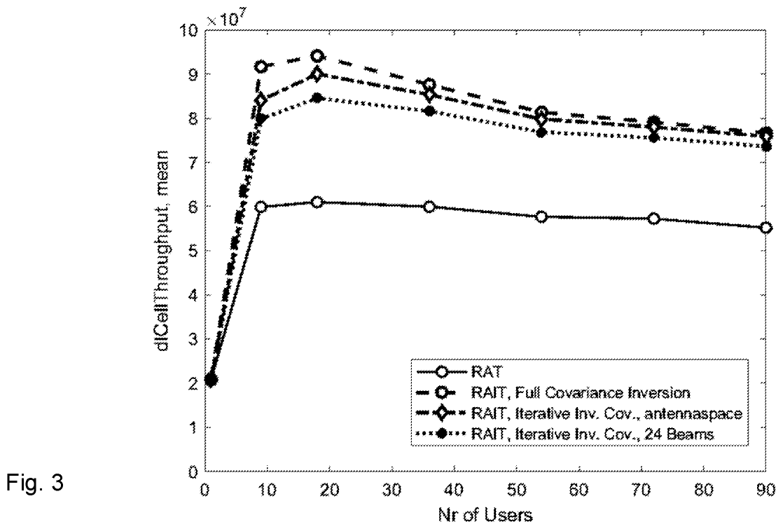

FIG. 3 illustrates the average downlink cell throughput for different RAIT precoding algorithms versus the number of users. FIG. 3 also shows the downlink cell throughput using the RAT precoder which does not have any out-of-cell interference suppression capability. The proposed antenna space iterative covariance inverse calculation algorithm yields a performance very close to that of the full matrix inversion RAIT algorithm.

FIG. 3 also shows the downlink cell throughput of the proposed beamspace iterative inverse covariance calculation algorithm where the active beams are selected based on the channel times inverse covariance power metric and dimension reduction is applied on the channel estimates only. Using only 24 reduced beams can still provide significant improvement in cell throughput over RAT beamforming. In particular, the beamspace precoding algorithm retains 85% of interference cancellation gain, i.e., the throughput gain over that achieved by the RAT precoder.

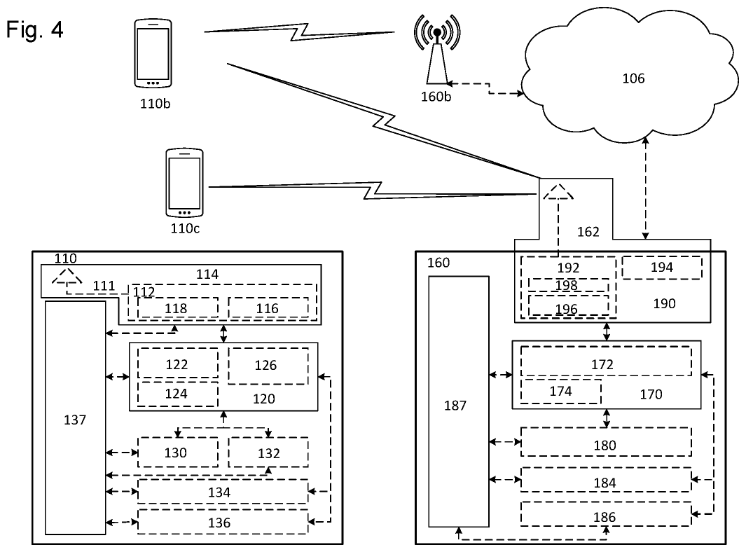

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

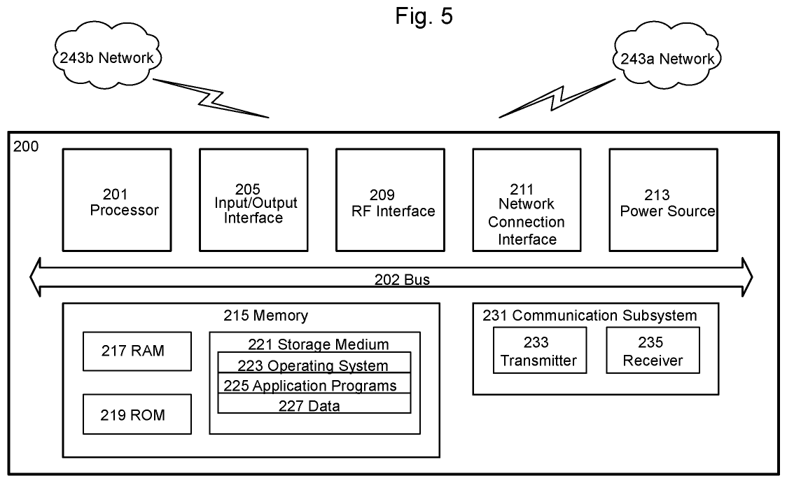

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication(MTC) UE, and/or an enhanced MTC (eMTC) UE. UE 200, as illustrated in FIG. 5, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

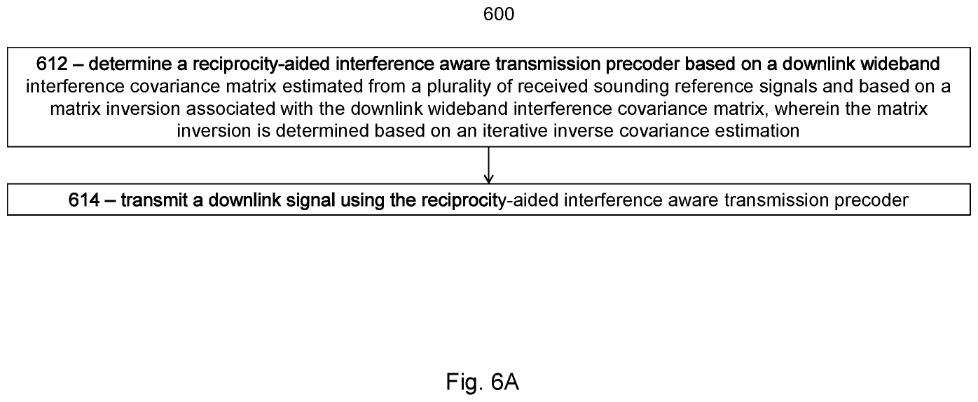

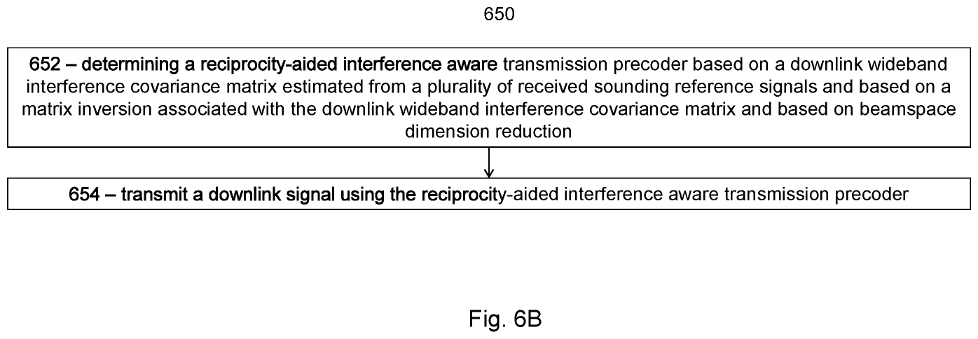

FIG. 6A is a flowchart illustrating an example method in a network node, according to certain embodiments. In particular embodiments, one or more steps of FIG. 6A may be performed by network node 160 described with respect to FIG. 4.

The method begins at step 612, where the network node (e.g., network node 160) determines a reciprocity-aided interference aware transmission precoder based on a downlink wideband interference covariance matrix estimated from a plurality of received sounding reference signals and based on a matrix inversion associated with the downlink wideband interference covariance matrix. The matrix inversion is determined based on an iterative inverse covariance estimation. The reciprocity-aided interference aware transmission precoder may be determined according to any of the embodiments and examples described herein.

For example, in particular embodiments the matrix inversion associated with the downlink wideband interference covariance matrix comprises a matrix inversion of a regularized version of the downlink wideband interference covariance matrix.

In particular embodiments, the iterative inverse covariance estimation comprises iteratively updating an inverse of the wideband interference covariance matrix from a plurality of channel estimation residual vectors using a sequence of rank one updates each corresponding to residual vector of the plurality of channel estimation residual vectors. The rank one updates may use the Woodbury matrix identity.

In particular embodiments, the iterative inverse covariance estimation comprises adding circular Gaussian noise vectors to each of the plurality of channel estimation residual vectors.

In particular embodiments, the iterative inverse covariance estimation comprises approximating instantaneous noise-dependent expressions by their expected values.

In some embodiments, the iterative inverse covariance estimation may be combined with beamspace reduction. For example, in particular embodiments, the determination of the reciprocity-aided interference aware transmission precoder is further based on beamspace dimension reduction. Beamspace dimension reduction may be applied on the downlink wideband inverse interference covariance matrix, on downlink channel estimates used for determining the reciprocity-aided interference aware transmission precoder, or both.

At step 614, the network node transmits a downlink signal using the reciprocity-aided interference aware transmission precoder. For example, the network node may transmit transmits a downlink signal using the reciprocity-aided interference aware transmission precoder to wireless device 110.

Modifications, additions, or omissions may be made to method 600 of FIG. 6A. Additionally, one or more steps in the method of FIG. 6A may be performed in parallel or in any suitable order.

FIG. 6B is a flowchart illustrating another example method in a network node, according to certain embodiments. In particular embodiments, one or more steps of FIG. 6B may be performed by network node 160 described with respect to FIG. 4.

The method begins at step 652, where the network node (e.g., network node 160) determines a reciprocity-aided interference aware transmission precoder based on a downlink wideband interference covariance matrix estimated from a plurality of received sounding reference signals and based on a matrix inversion associated with the downlink wideband interference covariance matrix. The determination is based on beamspace dimension reduction. The reciprocity-aided interference aware transmission precoder may be determined according to any of the embodiments and examples described herein.

For example, in particular embodiments, beamspace dimension reduction is applied on the downlink wideband inverse interference covariance matrix, on downlink channel estimates used for determining the reciprocity-aided interference aware transmission precoder, or both.

In particular embodiments, beamspace dimension reduction is based on a spatial discrete Fourier transform basis vector based on an antenna array configuration of the network node.

In particular embodiments, a set of active beams used for the beamspace dimension reduction is selected based on channel power and/or inverse interference covariance.

In particular embodiments, the set of active beams comprises a fixed number of beams. The set of active beams may comprise a minimum number of active beams with a total collected power greater than or equal to a predetermined value and/or a number of beams each with a power above a threshold value.

In some embodiments, the beamspace reduction may be combined with iterative inverse covariance estimation. For example, in particular embodiments the matrix inversion is determined based on an iterative inverse covariance estimation.

At step 654, the network node transmits a downlink signal using the reciprocity-aided interference aware transmission precoder. For example, the network node may transmit transmits a downlink signal using the reciprocity-aided interference aware transmission precoder to wireless device 110.

Modifications, additions, or omissions may be made to method 650 of FIG. 6B. Additionally, one or more steps in the method of FIG. 6B may be performed in parallel or in any suitable order.

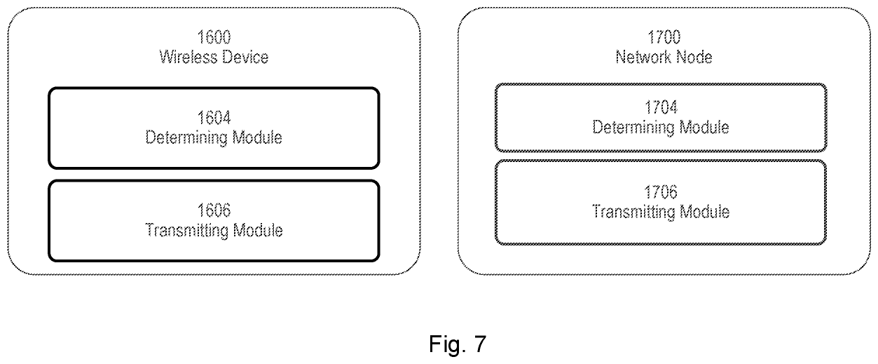

FIG. 7 illustrates a schematic block diagram of two apparatuses in a wireless network (for example, the wireless network illustrated in FIG. 4). The apparatuses include a wireless device and a network node (e.g., wireless device 110 and network node 160 illustrated in FIG. 4). Apparatuses 1600 and 1700 are operable to carry out the example methods described with reference to FIGS. 6A and 6B, respectively, and possibly any other processes or methods disclosed herein. It is also to be understood that the methods of FIGS. 6A and 6B are not necessarily carried out solely by apparatuses 1600 and/or 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause determining module 1604, transmitting module 1606, and any other suitable units of apparatus 1600 to perform corresponding functions according one or more embodiments of the present disclosure. Similarly, the processing circuitry described above may be used to cause determining module 1704, transmitting module 1706, and any other suitable units of apparatus 1700 to perform corresponding functions according one or more embodiments of the present disclosure.

As illustrated in FIG. 5, apparatus 1600 includes determining module 1604 configured to determine a reciprocity-aided interference aware transmission precoder according to any of the embodiments and examples described herein. Transmitting module 1606 is configured to transmit a signal using the reciprocity-aided interference aware transmission precoder according to any of the embodiments and examples described herein.

As illustrated in FIG. 5, apparatus 1700 includes determining module 1704 configured to determine a reciprocity-aided interference aware transmission precoder according to any of the embodiments and examples described herein. Transmitting module 1706 is configured to transmit a signal using the reciprocity-aided interference aware transmission precoder according to any of the embodiments and examples described herein.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1.-18. (canceled)

19. A method performed by a network node, the method comprising:
determining a reciprocity-aided interference aware transmission precoder based on a downlink wideband interference covariance matrix estimated from a plurality of received sounding reference signals and based on a matrix inversion associated with the downlink wideband interference covariance matrix, wherein the determination is based on beamspace dimension reduction; and
transmitting a downlink signal using the reciprocity-aided interference aware transmission precoder.

20. The method of claim 19, wherein beamspace dimension reduction is applied on the downlink wideband inverse interference covariance matrix.

21. The method of claim 19, wherein beamspace dimension reduction is applied on downlink channel estimates used for determining the reciprocity-aided interference aware transmission precoder.

22. The method of claim 19, wherein beamspace dimension reduction is based on a spatial discrete Fourier transform basis vector based on an antenna array configuration of the network node.

23. The method of claim 19, wherein a set of active beams used for the beamspace dimension reduction is selected based on channel power.

24. The method of claim 19, wherein a set of active beams used for the beamspace dimension reduction is selected based on inverse interference covariance.

25. The method of claim 19, wherein a set of active beams used for the beamspace dimension reduction is selected based on one or both of channel power and inverse interference covariance, and wherein the set of active beams comprises a fixed number of beams.

26. The method of claim 19, wherein a set of active beams used for the beamspace dimension reduction is selected based on one or both of channel power and inverse interference covariance, and wherein the set of active beams comprises a minimum number of active beams with a total collected power greater than or equal to a predetermined value.

27. The method of claim 19, wherein a set of active beams used for the beamspace dimension reduction is selected based on one or both of channel power and inverse interference covariance, and wherein the set of active beams comprises a number of beams each with a power above a threshold value.

28. The method of claim 19, wherein the matrix inversion is determined based on an iterative inverse covariance estimation.

29. A network node comprising processing circuitry configured to:
determine a reciprocity-aided interference aware transmission precoder based on a downlink wideband interference covariance matrix estimated from a plurality of received sounding reference signals and based on a matrix inversion associated with the downlink wideband interference covariance matrix, wherein the determination is based on beamspace dimension reduction; and
transmit a downlink signal using the reciprocity-aided interference aware transmission precoder.

30. The network node of claim 29, wherein beamspace dimension reduction is applied on the downlink wideband inverse interference covariance matrix.

31. The network node of claim 29, wherein beamspace dimension reduction is applied on downlink channel estimates used for determining the reciprocity-aided interference aware transmission precoder.

32. The network node of claim 29, wherein beamspace dimension reduction is based on a spatial discrete Fourier transform basis vector based on an antenna array configuration of the network node.

33. The network node of claim 29, wherein a set of active beams used for the beamspace dimension reduction is selected based on channel power.

34. The network node of claim 29, wherein a set of active beams used for the beamspace dimension reduction is selected based on inverse interference covariance.

35. The network node of claim 29, wherein a set of active beams used for the beamspace dimension reduction is selected based on one or both of channel power and inverse interference covariance, and wherein the set of active beams comprises a fixed number of beams.

36. The network node of claim 29, wherein a set of active beams used for the beamspace dimension reduction is selected based on one or both of channel power and inverse interference covariance, and wherein the set of active beams comprises a minimum number of active beams with a total collected power greater than or equal to a predetermined value.

37. The network node of claim 29, wherein a set of active beams used for the beamspace dimension reduction is based on one or both of channel power and inverse interference covariance, and wherein the set of active beams comprises a number of beams each with a power above a threshold value.

38. The network node of claim 29, wherein the matrix inversion is determined based on an iterative inverse covariance estimation.
